(19) United States
(12) Patent Application Publication
(10) Pub. No.: US 2017/0204927 A1
(43) Pub. Date: Jul. 20, 2017

(54) BALL SCREW ASSEMBLY FOR SPRING DOWNFORCE ACTUATOR ADJUSTMENT

(71) Applicant: STEERING SOLUTIONS IP HOLDING CORPORATION, Saginaw, MI (US)

(72) Inventors: Nicholas R. Alpers, Saginaw, MI (US); Eric J. Ford, Saginaw, MI (US)

(21) Appl. No.: 15/409,139

(22) Filed: Jan. 18, 2017

Related U.S. Application Data
(60) Provisional application No. 62/280,348, filed on Jan. 19, 2016.

(51) Int. Cl. F16F 1/04; A01B 61/04; A01B 63/00; F16H 25/22; F16H 57/027

(52) U.S. Cl. CPC F16F 1/041; F16H 25/2204; F16H 57/027; A01B 63/008; A01B 61/046; F16H 2025/2031

(57) ABSTRACT

A spring downforce actuator adjustment assembly includes a spring exerting a downforce on an object. Also included is a ball screw extending within an interior location defined by the spring. Further included is a ball nut threaded to the ball screw and in abutment with an end of the spring. Yet further included is a coupling connectable with an input device to rotate the ball screw, rotation of the ball screw translating the ball nut therealong and adjusting an effective length of the spring.

### CROSS-REFERENCE TO RELATED APPLICATION

This patent application claims priority to U.S. Provisional Patent Application Ser. No. 62/280,348, filed Jan. 19, 2016, which is incorporated herein by reference in its entirety.

### FIELD OF THE INVENTION

The embodiments described herein relate to spring downforce adjustment assemblies and, more particularly, to a ball screw assembly used to adjust downforce of a spring.

### BACKGROUND OF THE INVENTION

Manual adjustment of a shock absorber spring adjuster in order to alter characteristics of a shock absorber is time consuming, particularly when several systems are to be adjusted. Over time, threads of an adjustment mechanism can be damaged due to constant impact loads, thus making the assembly difficult to adjust. Additionally, foreign particles may be present in threaded regions, which challenge adjustment.

### SUMMARY OF THE INVENTION

According to one aspect of the disclosure, a spring downforce actuator adjustment assembly includes a spring exerting a downforce on an object. Also included is a ball screw extending within an interior location defined by the spring. Further included is a ball nut threaded to the ball screw and in abutment with an end of the spring. Yet further included is a coupling connectable with an input device to rotate the ball screw, rotation of the ball screw translating the ball nut therealong and adjusting an effective length of the spring.

According to another aspect of the disclosure, a spring downforce actuator adjustment assembly for an agricultural implementation includes a spring exerting a downforce on an object. Also included is a ball screw extending within an interior location defined by the spring. Further included is a ball nut threaded to the ball screw and in abutment with an end of the spring. Yet further included is a coupling connectable with an input device to rotate the ball screw, rotation of the ball screw translating the ball nut therealong and adjusting an effective length of the spring. Also included is a sealing assembly. The sealing assembly includes a first portion that is rigid, the first portion surrounding a first portion of the ball screw. The sealing assembly also includes a second portion that is flexible, the second portion surrounding a second portion of the ball screw.

According to yet another aspect of the disclosure, a method of manually adjusting a downforce actuator of an agricultural implementation is provided. The method includes coupling an output device of a manual adjustment mechanism to a coupling structure that is operatively coupled to a ball screw. The method also includes rotating the coupling to rotate the ball screw, rotation of the ball screw translating a ball nut threaded to the ball screw. The method further includes adjusting the effective length of a spring biased by the ball nut at an end of the spring.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a spring downforce actuator adjustment assembly; and

FIG. 2 is a perspective view of the spring downforce actuator adjustment assembly with a sealing assembly disposed thereon.

### DETAILED DESCRIPTION

Referring now to the Figures, various aspects of the disclosed embodiments are illustrated. Reference to specific embodiments is provided herein including, without limiting same, a ball screw assembly provided to improve manual adjustment efforts associated with adjusting a spring downforce.

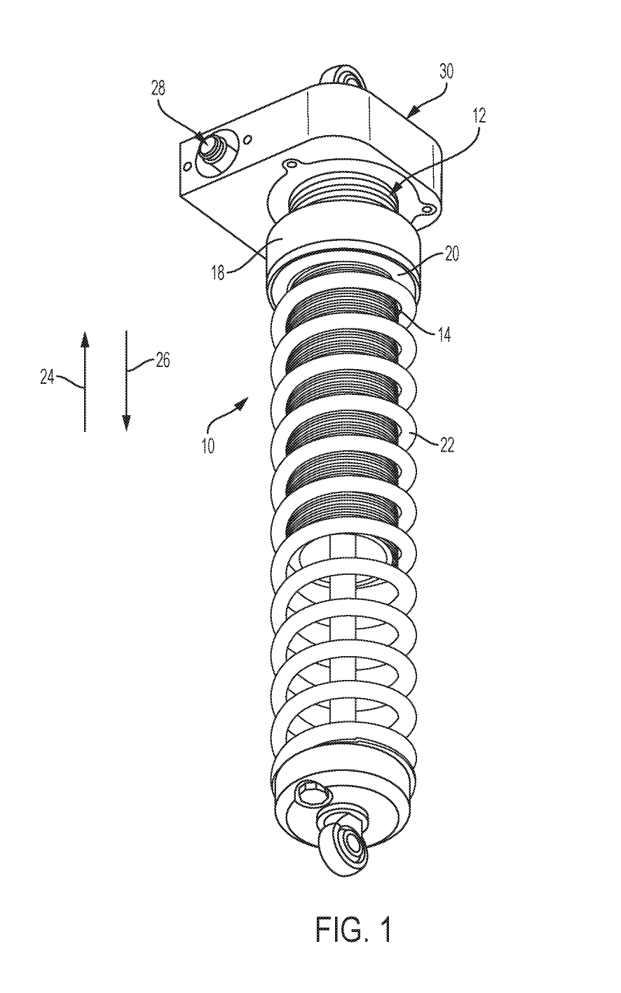

Referring now to FIG. 1, a ball screw assembly 10 is illustrated. The ball screw assembly 10 is employed in an agricultural application, such as an agricultural implement comprising an apparatus used in various farming activities, such as harvesting, planting and/or seeding. In such embodiments, an electric motor interacts with the ball screw assembly 10 which converts rotary motion of the electric motor to linear motion. The linear motion is applied to an output assembly, such as an adjustment mechanism of a planting apparatus. For example, a spring downforce may be adjusted to modify a planting depth of a planting apparatus. Although the ball screw assembly 10 is described above as being employed in an agricultural application, it is to be appreciated that the ball screw assembly 10 described herein may be used in other applications.

The ball screw assembly 10 includes a threaded screw 12 with a helical path 14 which, in conjunction with a ball nut 18, guides a plurality of balls therealong. The balls are load carrying during movement and urge the ball nut 18 along the threaded screw 12. It is to be appreciated that the balls may travel in either direction along the helical path 14, depending upon which direction the ball nut 18 is needed to travel.

The ball nut 18 is disposed in abutment with an end 20 of a spring 22. As the ball nut 18 translates along the ball screw 12, the effective length of the spring 22 is modified. In particular, as the ball nut 18 translates in a first direction 24, the effective length of the spring 22 is increased, while translation of the ball nut 18 in a second direction 26 results in a decrease in the effective length of the spring 22. This selective modification allows an operator to adjust the characteristics of an assembly with which the spring 22 is associated.

Adjustment of the spring 22 is facilitated by manually adjusting the ball nut 18 with a drill, purposed motor, non-electric hand tool (e.g., wrench) or the like in some embodiments. Specifically, the drill, motor or the like interacts with a coupling 28 to provide an input that rotates the ball screw 12 to linearly adjust the ball nut 18. In some embodiments, a gearbox 30 is provided to reduce the effort required to adjust the assembly 10. The ball screw 12 is formed of a high-strength material, such as a metal, that eliminates potential damage to the ball screw 12 from impact loading. By utilizing the ball screw assembly 10, a more efficient spring adjustment system is provided based on a significant reduction in time required to modify the effective length of the spring 22.

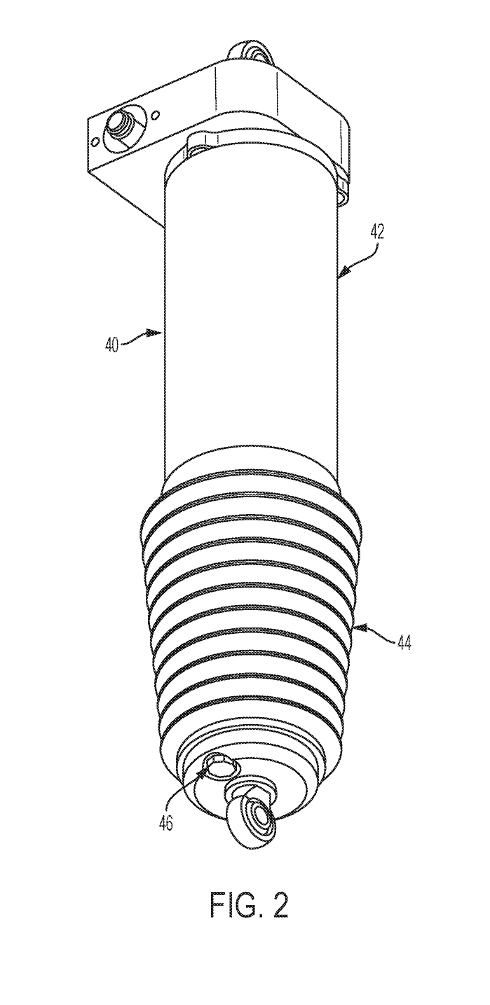

The automated suspension adjuster is accomplished by eliminating the burdensome adjustment procedures required by prior art embodiments, such as that disclosed in U.S. Pat. No. 5,044,614, which is incorporated by reference in its entirety. Furthermore, systems that are not presently adjustable can now be adjusted by adding the assembly shown in FIGS. 1 and 2.

Referring now to FIG. 2, a sealing assembly 40 is provided to eliminate the ingress of liquids and the potential of foreign debris on the ball screw 12. The sealing assembly 40 includes a casing 42 covering at least a portion of the ball screw 12. The casing 42 is clear in some embodiments to allow for visual monitoring during adjustment of the spring length. A convoluted, or stepped, boot 44 is attached to the casing 42 to allow movement. A vent sealing assembly 46 allows air flow to be introduced to the interior location proximate the ball screw 12.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A spring downforce actuator adjustment assembly comprising:
a spring exerting a downforce on an object;
a ball screw extending within an interior location defined by the spring;
a ball nut threaded to the ball screw and in abutment with an end of the spring; and
a coupling connectable with an input device to rotate the ball screw, rotation of the ball screw translating the ball nut therealong and adjusting an effective length of the spring.

2. The spring downforce actuator adjustment assembly of claim 1, further comprising a gearbox intermediately disposed between the coupling and the ball screw to reduce a required input torque for adjustment.

3. The spring downforce actuator adjustment assembly of claim 1, wherein the input device comprises one of a drill and an electric motor.

4. The spring downforce actuator adjustment assembly of claim 1, wherein the spring downforce actuator adjustment assembly is part of an agricultural implementation.

5. The spring downforce actuator adjustment assembly of claim 4, wherein the agricultural implementation is a seed planter.

6. The spring downforce actuator adjustment assembly of claim 1, further comprising a sealing assembly surrounding the ball screw.

7. The spring downforce actuator adjustment assembly of claim 6, wherein the sealing assembly comprises a casing.

8. The spring downforce actuator adjustment assembly of claim 7, wherein the casing is clear to allow visual inspection.

9. The spring downforce actuator adjustment assembly of claim 6, wherein the sealing assembly comprises a vent to allow air flow along the ball screw.

10. A spring downforce actuator adjustment assembly for an agricultural implementation comprising:
a spring exerting a downforce on an object;
a ball screw extending within an interior location defined by the spring;
a ball nut threaded to the ball screw and in abutment with an end of the spring;
a coupling connectable with an input device to rotate the ball screw, rotation of the ball screw translating the ball nut therealong and adjusting an effective length of the spring;
a sealing assembly comprising:
a first portion that is rigid, the first portion surrounding a first portion of the ball screw; and
a second portion that is flexible, the second portion surrounding a second portion of the ball screw.

11. The spring downforce actuator adjustment assembly of claim 10, wherein at least one of the first portion and the second portion of the sealing assembly are clear to allow visual inspection.

12. The spring downforce actuator adjustment assembly of claim 10, wherein the second portion of the sealing assembly includes a vent to allow air flow along the ball screw.

13. The spring downforce actuator adjustment assembly of claim 10, further comprising a gearbox intermediately disposed between the coupling and the ball screw to reduce a required input torque for adjustment.

14. The spring downforce actuator adjustment assembly of claim 10, wherein the input device comprises one of a drill and an electric motor.

15. The spring downforce actuator adjustment assembly of claim 10, wherein the spring downforce actuator adjustment assembly is part of an agricultural implementation.

16. The spring downforce actuator adjustment assembly of claim 15, wherein the agricultural implementation is a seed planter.

17. A method of manually adjusting a downforce actuator of an agricultural implementation comprising:
coupling an output device of a manual adjustment mechanism to a coupling structure that is operatively coupled to a ball screw;
rotating the coupling to rotate the ball screw, rotation of the ball screw translating a ball nut threaded to the ball screw; and
adjusting the effective length of a spring biased by the ball nut at an end of the spring.

18. The method of claim 17, further comprising reducing the input torque required with the manual adjustment mechanism with a gearbox disposed intermediately between the coupling structure and the ball screw.

19. The method of claim 17, wherein the manual adjustment mechanism comprises one of a drill, purposed motor and a non-electric hand tool.
